(19) United States
(12) Patent Application Publication
(10) Pub. No.: US 2013/0262277 A1
(43) Pub. Date: Oct. 3, 2013

(54) DYNAMIC FILTER GENERATION FOR ACCOUNT MANAGEMENT

(71) Applicants: John Clark, JR., Pepperell, MA (US); Rajesh Bhatia, Westport, CT (US); Shailesh Kumar, Littleton, MA (US); Greg Getchell, Littleton, MA (US)

(72) Inventors: John Clark, JR., Pepperell, MA (US); Rajesh Bhatia, Westport, CT (US); Shailesh Kumar, Littleton, MA (US); Greg Getchell, Littleton, MA (US)

(73) Assignee: Oracle International Corporation, Redwood Shores, CA (US)

(21) Appl. No.: 13/432,856

(22) Filed: Mar. 28, 2012

(51) Int. Cl. G06Q 40/00

(52) U.S. Cl. 705/30

(57) ABSTRACT

A method for dynamically filtering a plurality of accounts in an Account Reconciliation Management System may include determining a plurality of attributes, and receiving a selection of a first attribute in the plurality of attributes. The method may also include determining a plurality of values associated with a value type of the first attribute. The method may additionally include determining a plurality of operands associated with the first attribute. The method may further include receiving a selection of a first operand and a selection of a first value, and creating a filter expression based on the first attribute, the first value, and the first operand, and filtering the plurality of accounts. The method may additionally include determining that a second attribute in the plurality of attributes is not associated with any of the remaining accounts, and removing the second attribute from the plurality of attributes.

### BACKGROUND OF THE INVENTION

Organizations may deal with many financial accounts from many different sources according to various operations. Consequently, in order to reconcile and/or analyze relevant data, an organization may deal with hundreds, thousands, or even millions of separate accounts. Furthermore, accounts may often not be consistently defined. Each account may have many different attributes associated with it, and any two accounts may have different attributes. Because the wide diversity of business processes that may be associated with a financial account, different departments within an organization may need to use attributes that are unique to that department. Therefore, organizations with multiple departments may further complicate account definitions.

Because of the vast number of accounts, and because of the wide variation in how accounts are defined, filtering methods may require a user to sift through a large number of options in order to find needed accounts. Furthermore, finding an account may include multiple filtering levels that include complicated decisions at each level. Thus, in order to deal with diverse business processes, as well as the many different types of accounts that may be associated with these processes, improvements are necessary in the art.

### BRIEF SUMMARY OF THE INVENTION

In one embodiment, A method for dynamically filtering a plurality of accounts in an Account Reconciliation Management System includes determining a plurality of attributes, wherein each of the plurality of attributes is associated with at least one of the plurality of accounts, and receiving a selection of a first attribute in the plurality of attributes. The method may also include determining a plurality of values, wherein each of the plurality of values are associated with a value type of the first attribute, and determining a plurality of operands, wherein each of the plurality of operands are associated with the first attribute. The method may additionally include receiving a selection of a first operand from the plurality of operands, and receiving a selection of a first value from the plurality of values. The method may further include creating a filter expression based on the first attribute, the first value, and the first operand, and filtering the plurality of accounts, wherein the filtering comprises removing accounts from the plurality of accounts that do not satisfy the filter expression. The method may also include, after filtering the plurality of accounts, determining that a second attribute in the plurality of attributes is not associated with any of the remaining accounts in the plurality of accounts, and removing the second attribute from the plurality of attributes.

In another embodiment, a computer-readable memory having stored thereon a sequence of instructions which, when executed by one or more processors, causes the one or more processors to filter a plurality of accounts in an Account Reconciliation Management System by determining a plurality of attributes, wherein each of the plurality of attributes may be associated with at least one of the plurality of accounts; receiving a selection of a first attribute in the plurality of attributes; determining a plurality of values, wherein each of the plurality of values may be associated with a value type of the first attribute; determining a plurality of operands, wherein each of the plurality of operands are associated with the first attribute; receiving a selection of a first operand from the plurality of operands; receiving a selection of a first value from the plurality of values; creating a filter expression based on the first attribute, the first value, and the first operand; filtering the plurality of accounts, wherein the filtering comprises removing accounts from the plurality of accounts that do not satisfy the filter expression; after filtering the plurality of accounts, determining that a second attribute in the plurality of attributes is not associated with any of the remaining accounts in the plurality of accounts; and removing the second attribute from the plurality of attributes.

In yet another embodiment, a system includes a processor, and a memory communicatively coupled with and readable by the processor and having stored therein a sequence of instructions which, when executed by the processor, cause the processor to filter a plurality of accounts in an Account Reconciliation Management System by: determining a plurality of attributes, wherein each of the plurality of attributes may be associated with at least one of the plurality of accounts; receiving a selection of a first attribute in the plurality of attributes; determining a plurality of values, wherein each of the plurality of values may be associated with a value type of the first attribute; determining a plurality of operands, wherein each of the plurality of operands may be associated with the first attribute; receiving a selection of a first operand from the plurality of operands; receiving a selection of a first value from the plurality of values; creating a filter expression based on the first attribute, the first value, and the first operand; filtering the plurality of accounts, wherein the filtering comprises removing accounts from the plurality of accounts that do not satisfy the filter expression; after filtering the plurality of accounts, determining that a second attribute in the plurality of attributes is not associated with any of the remaining accounts in the plurality of accounts; and removing the second attribute from the plurality of attributes.

### BRIEF DESCRIPTION OF THE DRAWINGS

A further understanding of the nature and advantages of the present invention may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a block diagram illustrating components of an exemplary operating environment in which various embodiments of the present invention may be implemented.

FIG. 2 illustrates a block diagram illustrating an exemplary computer system in which embodiments of the present invention may be implemented.

FIG. 3 illustrates a block diagram of a filtering system for filtering a plurality of accounts, according to one embodiment.

FIG. 4A illustrates a flowchart of a method for dynamically filtering accounts, according to one embodiment.

FIG. 4B illustrates a flowchart illustrates a method for further dynamically filtering accounts, according to one embodiment.

FIG. 5 illustrates a block diagram of accounts and attributes, according to one embodiment.

FIG. 6 illustrates a block diagram of a plurality of attributes, according to one embodiment.

FIG. 7 illustrates a block diagram of the creation of a filter expression from a first attribute, first value, and first operand, according to one embodiment.

FIG. 8 illustrates a block diagram of filtering the plurality of accounts according to a filter expression, according to one embodiment.

FIG. 9 illustrates a block diagram for dynamically adjusting the plurality of attributes for subsequent filtering operations, according to one embodiment.

FIG. 10 illustrates an interface for generating, editing; and saving filter expressions, according to one embodiment.

FIG. 11 illustrates an interface that may be used to manage filters, according to one embodiment.

FIG. 12A illustrates an interface for defining filter expressions, according to one embodiment.

FIG. 12B illustrates a second interface for defying filter expressions, according to one embodiment.

FIG. 13A illustrates an interface for filtering by segments account, according to one embodiment.

FIG. 13B illustrates an interface for filtering by a security segment, according to one embodiment.

FIG. 14A illustrates an interface for designing a basic filter, according to one embodiment.

FIG. 14B illustrates an interface for designing advanced filter expressions, according to one embodiment.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Presented herein are embodiments for dynamically adjusting filtering options available to a user at each step in a filtering process. Accounts may be associated with attributes, and the values of these attributes may be used to filter the accounts. At each stage, attributes may be presented for designing a filter expression. After the accounts have been filtered, the attributes may be dynamically adjusted to remove any attributes that are no longer associated with any of the remaining accounts. Thus, the process may be designed to handle a large number of accounts with many attributes without overwhelming a user. New attributes may be defined for accounts, stored in different locations for different purposes, and yet handled similarly by the filtering application. A user may switch between basic filters and advanced filters, where advanced filters include Boolean combinations and hierarchical groupings.

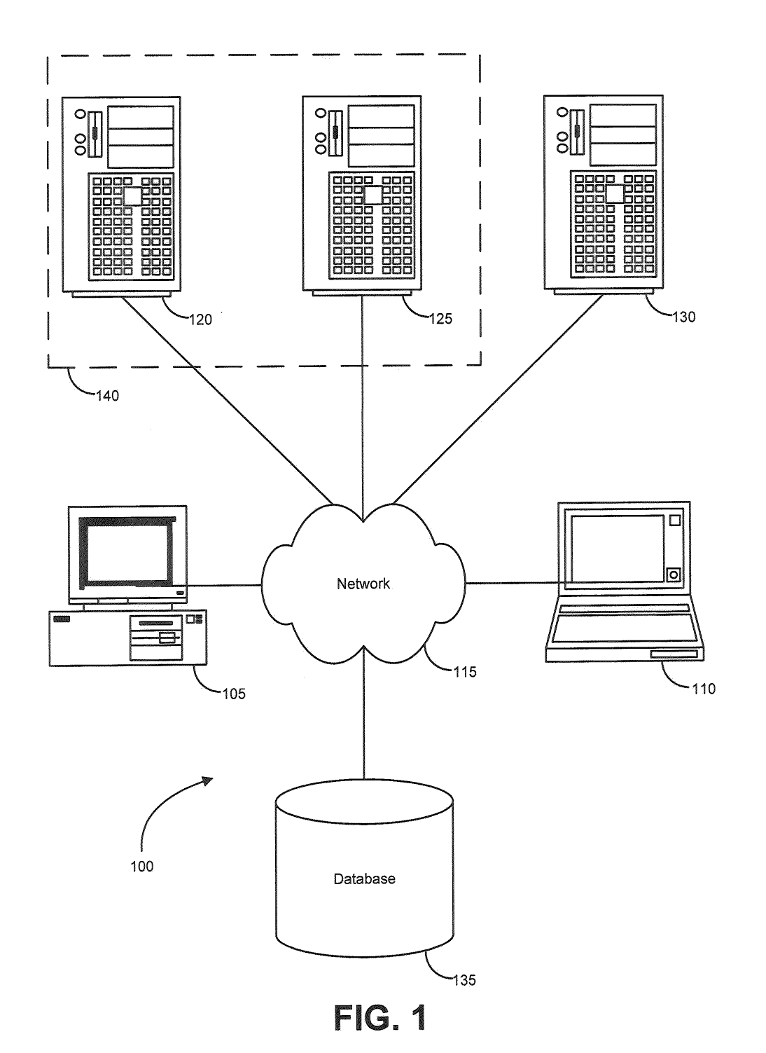

The embodiment disclosed herein may implemented in a computer system. FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may can be any type of network familiar to those skilled in the art that can support data communications using any of a variety of commercially-available protocols, including without limitation TCP/IP, SNA, IPX, AppleTalk, and the like. Merely by way of example, the network 115 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

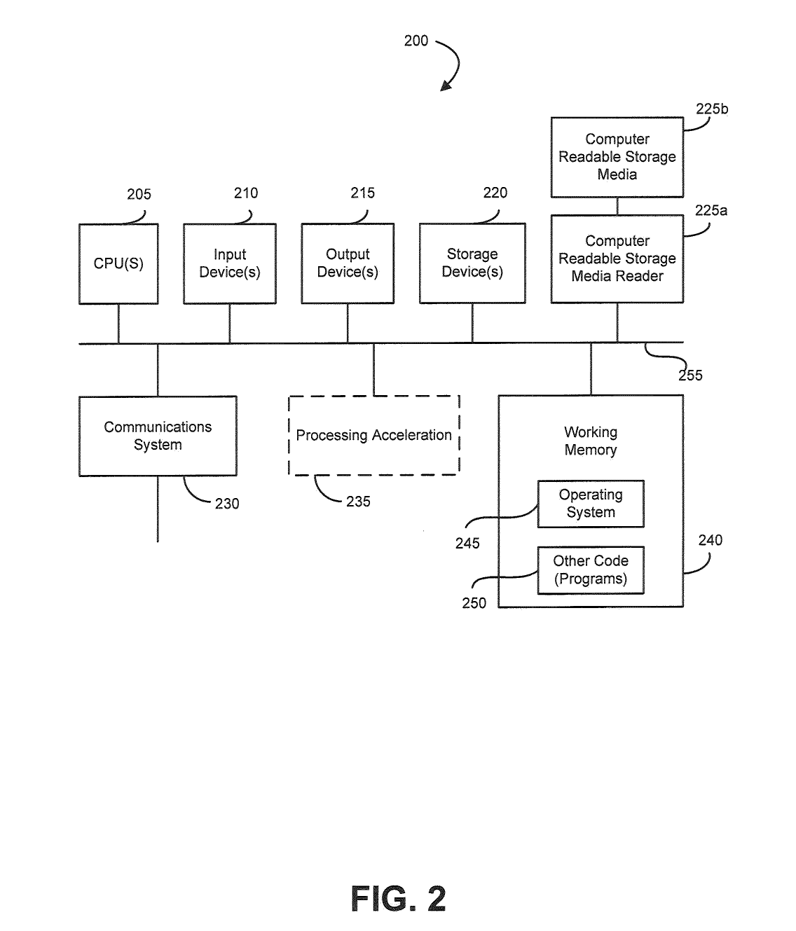

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

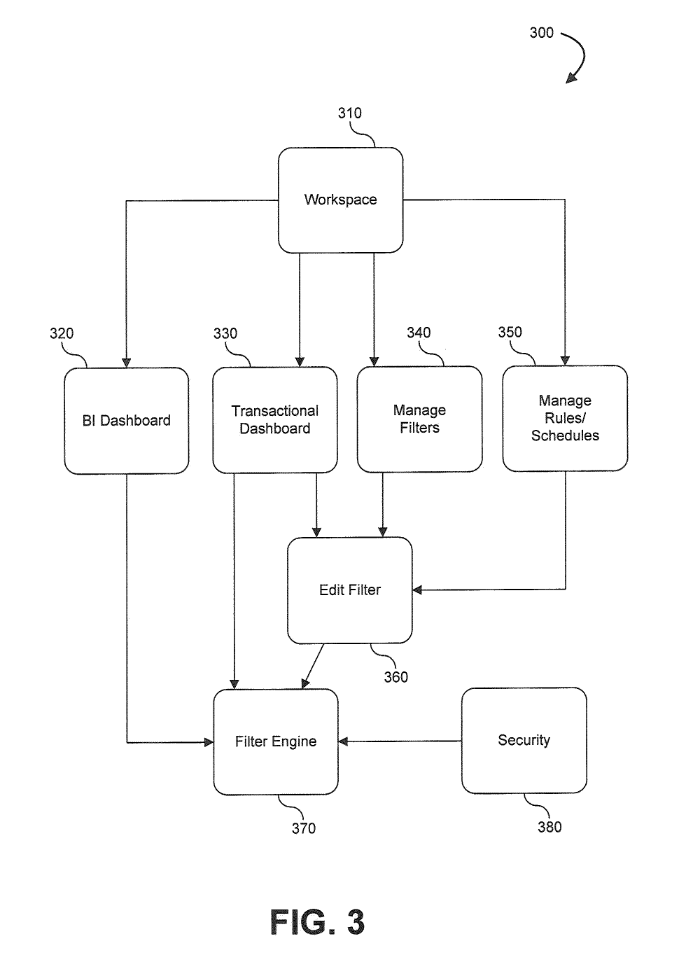

FIG. 3 illustrates a block diagram of a filtering system 300 for filtering a plurality of accounts, according to one embodiment. Filtering system 300 may be implemented in a computer system, such as computer system 200 of FIG. 2. Each of the modules in filtering system 300 may be implemented using any combination of hardware and/or software, and may further be combined or divided in different embodiments. For example, one or more of the modules of filtering system 300 may be combined into a single module, and or a single module of filtering system 300 may be divided into multiple modules. Also, the various modules may be communicatively coupled to each other in arrangements other than those shown in FIG. 3. For example, security module 380 may communicate with the edit filter module 360. Likewise, the filter engine module 370 may be bidirectionally coupled to the transactional dashboard 330.

Filtering system 300 may be comprised of a workspace module 310. The workspace module 310 may be part of a larger workspace dedicated to processes other than account filtering. Alternatively, filtering system 300 may be a standalone application specifically tailored for filtering accounts. Workspace module 310 may provide environments in which the other modules may operate, and in which a user may interact with the other modules. Workspace module 310 may be comprised of a number of sub-interfaces and modules with which a user may interact. One such module may be the BI dashboard module, which provides several aggregate reporting views of reconciliation account data. Other dashboard modules the also be included that are not shown in FIG. 3.

One particular dashboard, the transactional dashboard 330 may be comprised of a user interface specifically designed for user to interact with filter objects. For example the transactional dashboard 330 may be comprised of a user interface that allows a user to select, create, delete, save, edit, and/or assign various filters. The transactional dashboard 330 may present the user with a number of interfaces or windows configured to allow a user to graphically manipulate the definitions of filters. The transactional dashboard 330 may work in conjunction with a manage filters module 340. The manage filters module 340 may be a specific dialog available from a menu of the workspace module 310. In one embodiment, the manage filters module 340 may list all the filters available to a user. Specifically, it may list both a user's private filters as well as any public filters available in the workspace. From this dialogue, a user may create new filters and edit, view or delete any other filters depending on the user's privileges. The transactional dashboard 330 and/or the manage filters module 340 may allow user to search various filters according to their filter characteristics.

A manage rules/schedules module 350 may provide a dialogue or user interface that allows the user to assign profiles to filters and to apply rules to schedules. Rules may allow specific changes to a set of records and/or accounts based on a filter attribute stored within the rule. By storing the changes to be made and the filter together, the rule may be reapplied to future data sets. For example, a rule could have an action of “Set the Preparer to John Doe,” and the associated filter could be “Reconciliation Priority is High.” The manage rules/schedules module 350, along with the transactional dashboard 330 and the manage filters module 340 may provide inputs to an edit filter module 360. The edit filter module 360 may be used to create filter objects, and to define attributes, operators, and/or values for filter objects. The edit filter module 360 may also be used to combine multiple filter objects into a single filter object that operates on a plurality of attributes and/or value ranges.

A filter engine module 370 may receive inputs from each of the other modules and dynamically apply filter conditions to viewable accounts. The filter engine module 370 may accept one or more filter objects and apply those filters to a plurality of accounts. After each filtering stage, the filter engine module 370 may dynamically adjust the attributes, operands, and/or values that may be available to a user to create a subsequent filter. The types of filters that may be available to a user may depend on the user's identity and/or credentials. A security module 380 may operate to verify a user's identity and/or authenticate a user's credentials. Certain filter definitions may only be available to certain users, and the security module 380 may be used to protect the types of filters.

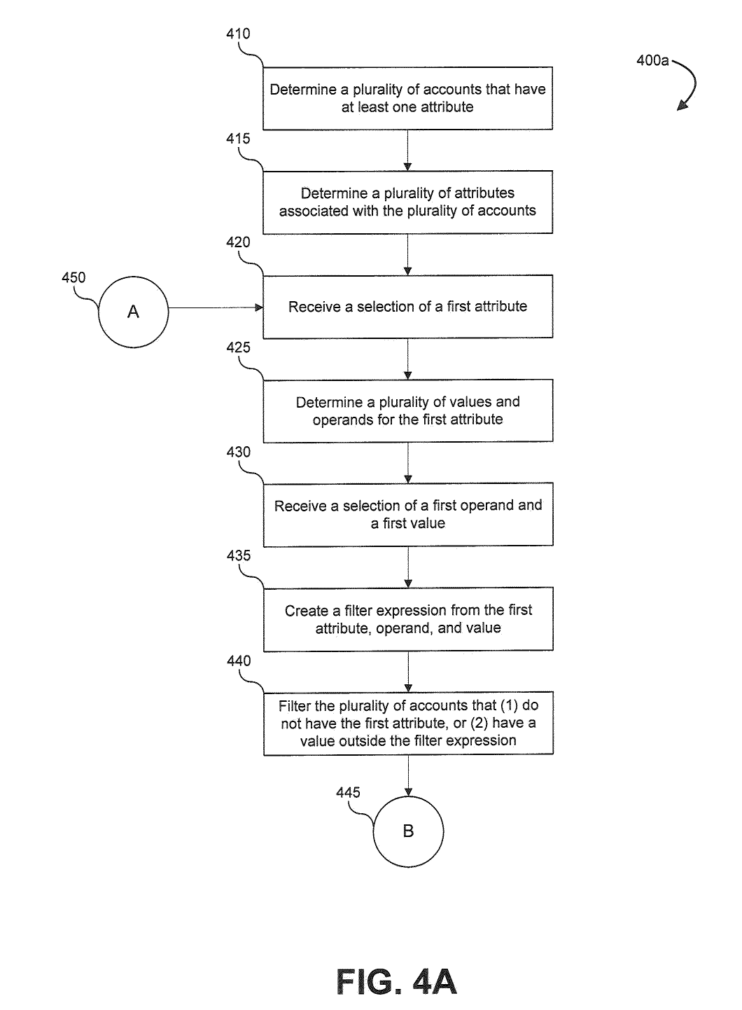

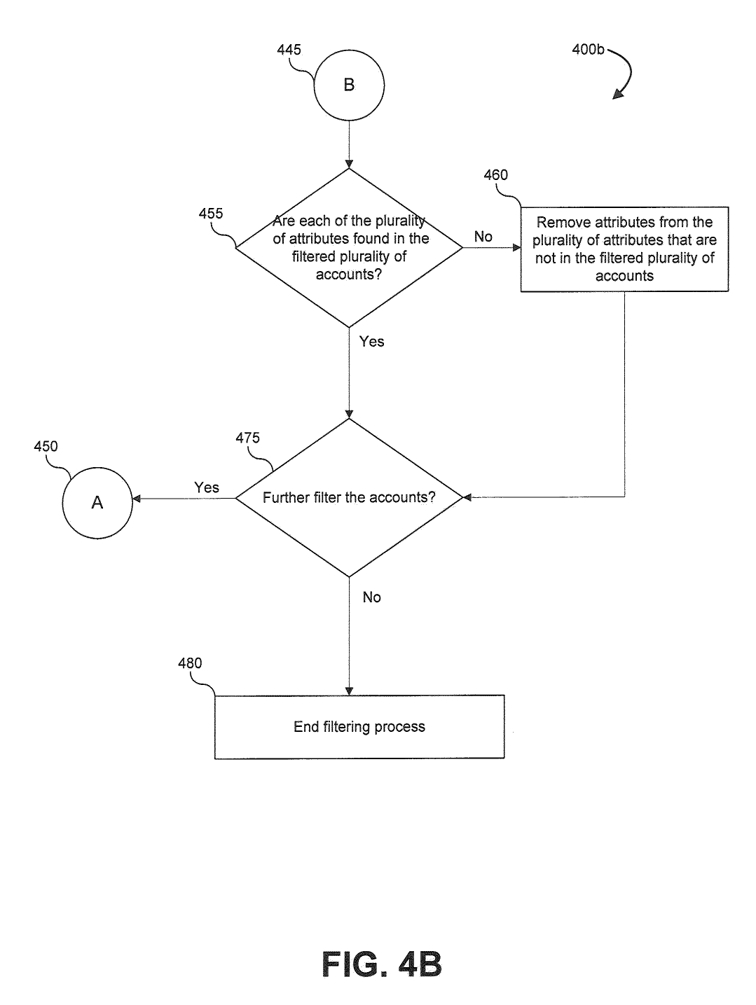

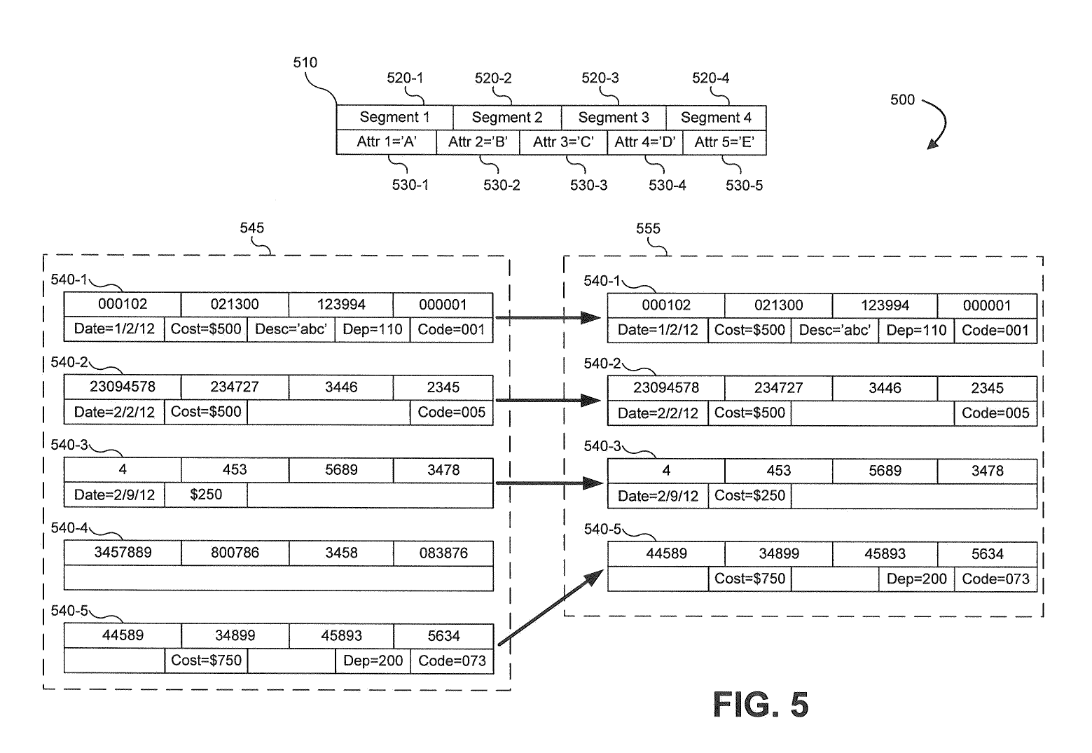

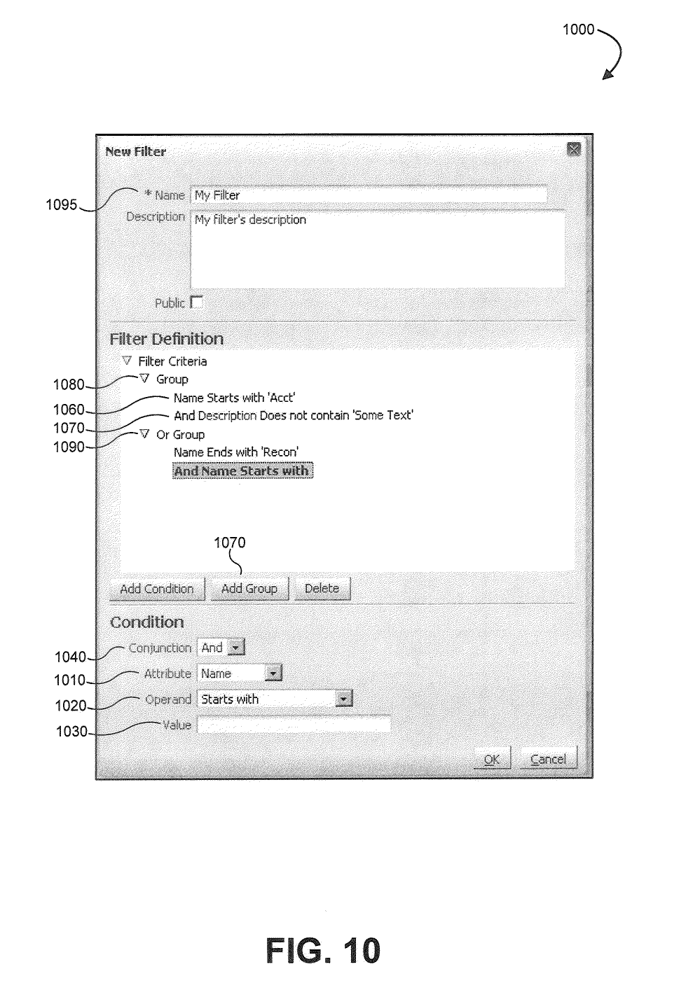

Turning now to a method for dynamically filtering accounts, a general overview of the process may first be presented, followed by specific details for each step in the process accompanied by examples. FIG. 4A and FIG. 4B illustrate flowcharts of such a method. FIG. 5 through FIG. 9 illustrate examples corresponding to one or more of the steps. FIG. 10 through FIG. 14 illustrate user interfaces that may be used to provide variations on some of the steps in some embodiments. Therefore the embodiments discussed in the flowcharts should be interpreted in light of the ensuing detailed descriptions of each step that accompanied the remaining figures. Furthermore, one more steps in these methods may be omitted, or additional steps may be added that are not shown in the figures that are discussed elsewhere in this disclosure. These methods are not meant to be limiting, but are simply illustrations of a few exemplary embodiments. Many other variations on these methods are contemplated herein, and may be implemented in light of this disclosure.

The following methods may be implemented by a computer system, such as computer system 200 in FIG. 2. Each step of these methods may be done automatically by the computer system, and or may be provided as inputs and/or outputs to a user. For example a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a Web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and or requests to and from the computer system which may or may not involve a user. Therefore, it will be understood in light of this disclosure, that each step and each method described herein may be altered to include an input and output to and from a user, or may be done automatically by a computer system.

FIG. 4A illustrates a flowchart 400a of a method for dynamically filtering accounts, according to one embodiment. The method may begin with a listing of accounts from various sources. At step 410, a plurality of accounts may be derived from the listing accounts according to attributes that may be associated with those accounts. For example, the plurality of accounts may be a subset of the listing of accounts. The plurality accounts may furthermore include accounts that are associated with at least one attribute. In one embodiment, accounts associated with no attributes may be omitted from the plurality of accounts. At step 415, a plurality of attributes may be derived from the plurality of accounts. In one embodiment, each of the plurality of accounts may be analyzed, and every attribute associated with at least one account may be added to the plurality of attributes.

At step 420, a selection may be received of a first attribute from the plurality of attributes. Again, this selection may be received as input from the user, and may be received in response to an output requesting such. Alternatively, this selection may be received from another source, or may be generated automatically, or selected automatically by a computer system. At step 425, a plurality of values and a plurality of operands may be determined which correspond the first attribute. Attributes may be associated with certain types of operands and/or values by their definitions, and the plurality of values and/or plurality of operands may correspond to the possible values and/or operands for the first attribute. In one embodiment other operands and values may be eliminated from the plurality of values and/or the plurality of operands, even though they, are associated with the first attribute.

At step 430, the selection of a first operand and a selection of a first value may be received. The first operand may be a member of the plurality of operands, and the first value may be a member of the plurality of values. At step 435, a filter expression may be created from the first attribute, the first operand, and the first value. In one embodiment, the filter expression may be a simple logical expression wherein the first operand relates the first value to the first attribute. In other embodiments, more complex filter expressions may be derived from multiple selections, as will be discussed further herein below. At step 440, the plurality of accounts may be filtered according to the filtering expression. In one embodiment, accounts in the plurality of accounts that are not associated with the first attribute may be removed by the filtering processes. In another embodiment, accounts in the plurality accounts may be associated with the first attribute, a but the value assigned to the first attribute may fall outside of the filter expression according to the relationship created by the first operand and the first value. In other embodiments, different filtering techniques may be used as the described further herein below.

FIG. 4B illustrates a flowchart 400b illustrates a method for further dynamically filtering accounts, according to one embodiment. In one embodiment, flowchart 400b may be a continuation of flowchart 400a according to step 445 labeled “B”. After the plurality of accounts has been filtered according to the filtering expression, the plurality of attributes may be dynamically adjusted according to the filtered plurality of accounts. At step 455, it may be determined whether each of the plurality of attributes are also associated with an account in the filtered plurality recounts. If there are attributes in the plurality of attributes that are no longer associated with any of the filtered plurality of accounts, then those attributes may be removed from the plurality of attributes according to step 460.

After the plurality of attributes has been dynamically adjusted, or if no attributes needed to be removed from the plurality of attributes, it may be determined whether a subsequent filtering step is needed. At step 475, an input may be received, or a computer system may determine that further filtering of the filtered plurality of accounts should occur. If such further filtering should occur, then the method may proceed to step 420 of flowchart 400a in FIG. 4A according to step 450 labeled “A”. Alternatively, if no further filtering is to be carried out, the filtering process may end. The final state of the filtered plurality of accounts may be recorded in memory, presented to a user on a display device, sent as a data stream to another software process, and/or the like.

FIG. 5 illustrates a block diagram 500 of accounts and attributes, according to one embodiment. Account 510 is one example of an account with data segments 520 and attributes 530. The account 510 may have a data field that is divided into various data segments 520. In one embodiment, these data segments 520 may correspond to portions of an account number. It may be beneficial to filter an account by a portion of an account number, and therefore in one embodiment, the data segments 520 may each be considered an attribute, although not specifically labeled as such. For example, one attribute may be segment 520-2 corresponding to a particular section account number, such as a portion of the account number that distinguishes between a savings account, a checking account, a corporate spending account, and/or other types of accounts. Therefore, segment 520-2 may be an attribute with associated operands and values that may be used in a filter expression.

Multiple attributes 530 may be associated with account 510. For example, account 510 may have five attributes associated with it, namely attribute 530-1, attribute 530-2, attribute 530-3, attribute 530-4, and attribute 530-5; while account 540-4 does not have any attributes associated with it. Attributes may be stored as fields within an account software object. In this case, a list of attributes may be included with each account object. In one embodiment, if an attribute is stored with an account in the attribute may have a valid value associated with it. In another embodiment, each account has a field for every possible attribute, and attributes that are not associated with that account may have a “null” value, or some other value that indicates the attribute is not associated with the account.

In one embodiment, attributes 530 may each include a name, a value type, and a value. For example in account 510, attribute 530 has an attribute name of “Attr 1”, a value type of “character string”, and a value of “A”. Many different value types are possible, further including integers, floating points, dates, currency, characters, and/or the like. In another example, account 540-1 includes an attribute with the attribute name “Date”, a value type of “Calendar”, and an attribute value of “1/2/12”. Although only simple value types and attributes are shown in FIG. 5, more complex attributes are possible. In one embodiment, attributes may have multiple values, value ranges, and mixed value types. For example, an attribute may have two value types and multiple values for each of those value types. Furthermore, attributes may be constructed from other attributes. Such complex attributes may be a collection of simple attributes or other complex attributes. In such cases, each attribute may have multiple operands and values that may be used in filtering expressions. Although most of this discussion will focus on simple filtering expressions involving single attribute values for brevity, it will be understood in light of this disclosure that the same filtering expressions may be used with complex attributes having multiple values and/or multiple value types.

A listing of accounts 545 may be generated from multiple sources. For example, the listing accounts 545 may be provided from different departments, different financial institutions, different users, different network resources, and/or the like. One advantage of some embodiments is that each of these different account sources may use different data structures and/or different attributes. Embodiments described herein therefore may dynamically assess the listing of accounts and extract attributes, no matter their source, and use them to build filtering expressions. This may provide a flexible account filtering system that does not have to rely on hard-coded attribute definitions in the filtering software, but may instead adjust according to the attributes of the accounts that need to be filtered. In one embodiment, however, the listing of accounts 545 includes accounts from a single data source.

The listing of accounts 545 include many accounts 540 that may be treated in a similar fashion without regard for their source. In one embodiment, a plurality of accounts 555 may be extracted as a subset of listing accounts 545. The plurality of accounts 555 may be a subset of the listing of accounts 545 that includes accounts that have at least one attribute associated with them. For example, the plurality of accounts 555 includes each account 540 from the listing of accounts 545 that are associated with at least one attribute. In this case, account 540-1, account 540-2, account 540-3, and account 540-5 have been included in the plurality of accounts 555 because each contain at least one attribute. Account 540-4 has been excluded from the plurality of accounts 555 because it is not associated with any attributes.

In this example, the plurality accounts 555 has been chosen based on whether or not they are associated with additional attribute. However, other ways of extracting a plurality of accounts 555 may be used by other embodiments. For instance, it may be determined that some attributes are undesirable when used in filtering expressions. In one embodiment, accounts associated with undesirable attributes may also be excluded from the plurality of accounts 555. In another embodiment, accounts may be excluded from the plurality recounts based on security credentials of a user. For example, accounts may be excluded for which a user is not authorized.

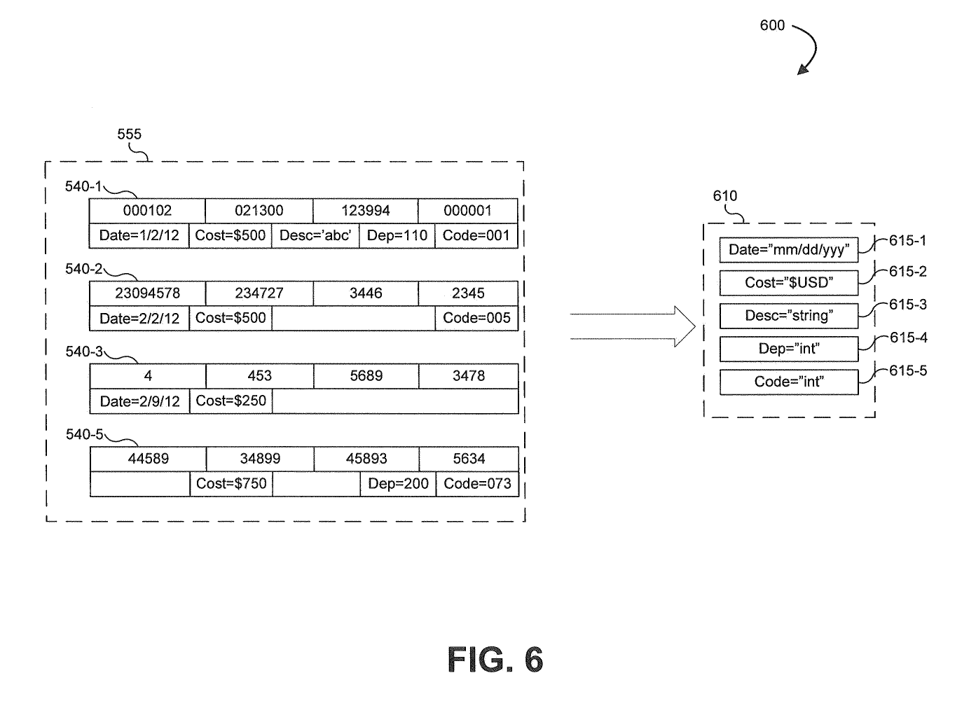

FIG. 6 illustrates a block diagram 600 of a plurality of attributes 610, according to one embodiment. After the plurality of accounts 555 for filtering has been determined, a plurality of attributes 610 to be use in a filtering expression may also be determined. In the simplest case, the plurality of attributes may be a subset of the attributes that are associated with the accounts 540 in the plurality of accounts 555. For example, the plurality of attributes 610 may be determined by cycling through each account 540 and adding each attribute to the plurality of attributes 610 if it does not already exist in the plurality of attributes 610. In this case, there may be five unique attributes, each assigned to at least one of the accounts 540 in the plurality accounts 555. These attributes are named “Date”, “Cost”, “Desc”, “Dep”, and “Code”.

In other embodiments, more complex methods of deriving a plurality of attributes 610 may be used. In one embodiment, attributes may be weighted and scored according to the total number of attributes assigned to accounts 540. For example, an attribute deemed to be important may be heavily weighted and thus require only a single occurrence in the plurality of accounts 555. Conversely, an attribute seems to be less important may require multiple occurrences in the plurality of accounts 555 in order to be included in the plurality of attributes 610. In another embodiment, attributes may be excluded based on security credentials of the user. For example, an attribute that contains confidential information may be excluded from the plurality of attributes 610 if the user is not authorized to access the confidential information. Additionally or alternatively, some attributes may contain system information, i.e. information that may not be useful in creating a filter expression. These attributes may also be excluded.

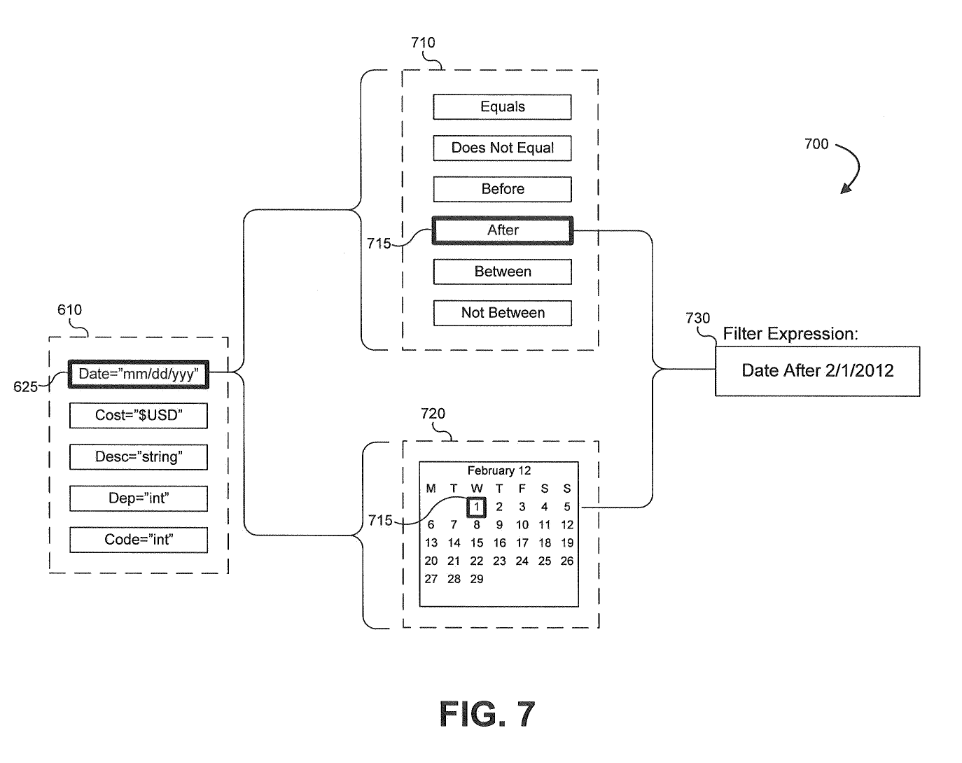

In FIG. 7, a block diagram 700 illustrates the creation of a filter expression from a first attribute 625, first value 725, and first operand 715, according to one embodiment. First, the first attribute 625 may be selected from the plurality of attributes 610. This selection may be in response to an output from the computer system requesting such, it may be provided by the user, or the selection may be determined automatically by the computer system. In this example, the first attribute 625 may be the “Date” attribute, having a value type corresponding to a calendar date formatted as “mm/dd/yyyy”. Note that in this embodiment the plurality of attributes 610 from which the first attribute 625 is selected need not include any particular value. The plurality of attributes 610 need only include attribute names from which the user can select an attribute, and a value type that may be derived from a set of operands.

From the selection of the first attribute 625, a plurality of operands 710 may be derived. Each of the plurality of operands 710 may be based on the value type of the first attribute 625. For example, because the first attribute 625 has a value type corresponding to a calendar date, each of the plurality of operands 710 may be one which may operate on a date. These operands may include, for example, “equals”, “does not equal”, “before”, “after”, “between”, and “not between”. These operands are merely illustrative, and are not meant to be limiting. An additional listing of some of the possible operands for each value type are included below in table 1.

TABLE 1
Sample Attributes and Operands

| | | | LoV/ | | |
|---|---|---|---|---|---|
| | Text | Numeric | Boolean | Date | User |
| Condition | Attribute | Attribute | Attribute | Attribute | Attribute |
| Starts With | Yes | No | No | No | No |
| Ends With | Yes | No | No | No | No |
| Equals | Yes | Yes | Yes | Yes | Yes |
| Does Not | Yes | Yes | Yes | Yes | Yes |
| Equal | | | | | |
| Less Than or | No | Yes | No | No | No |
| Equal To | | | | | |
| Greater Than | No | Yes | No | No | No |
| or Equal To | | | | | |
| Before | Yes | No | No | Yes | No |
| After | Yes | No | No | Yes | No |
| Between | Yes | Yes | No | Yes | No |
| Not Between | Yes | Yes | No | Yes | No |
| Contains | Yes | No | No | No | No |
| Does Not | Yes | No | No | No | No |
| Contain | | | | | |
| Is Blank | Yes | Yes | Yes | Yes | No |
| Is Not Blank | Yes | Yes | Yes | Yes | No |

From the plurality of operands 710, a first operand 715 may be selected. As before, this selection may be in response to an output from the computer system requesting such, it may be provided by the user, or the selection may be determined automatically by the computer system. In this example, the first operand 715 corresponds to the operand “after”, which may be used to create a filter expression to find date attributes “after” a certain date.

In this embodiment, the first operand 715 may be selected from the plurality of operands 710. In another embodiment, the first operand 715 may be provided by a user or another software process, and the first operand 715 need not be included in the plurality of operands. For example, in one embodiment, a user may provide a custom operand that may include instructions detailing how the operand should interact with the value type of the first attribute 625. For the “date” attribute, a new operand called “weekday” may be provided along with instructions that tell the computer system how to determine if a particular date is a weekday. A custom attribute may be added for a single filter expression, or may be saved to the list of attributes for the particular value type such that it can be used again in the future.

In addition to selecting a first operand 715, the first value 725 may be selected that corresponds to the value type of the first attribute 625. In one embodiment, a list of possible values corresponding to the value type of the first attribute 625 may be presented to a user, and user may select one value from among the possible values presented. For example, the value type of the data attribute may cause a calendar control to be presented to a user, where the user can select a particular date from the calendar control. Other value types such as “floating point”, “text string” or “integer” may not be as susceptible to a list of possible values. In these cases, the selection of the first value may include a user entering a particular number, character string, and/or the like, into a text box or via another input method.

In one embodiment, a default value may be set as the first value 725 unless it is overridden by input. The default value may be based on the current date, a threshold dollar amount, and/or some other value that may be programmed into the computer system. Alternatively, the default value may be the most common value of the first attribute 625 within the plurality of attributes 610. For example, account 540-1 and account 540-2 in FIG. 6 both have a “cost” attribute with a value of “$500”. Because the value of “$500” appears more than any other value of the “cost” attribute, “$500” may be the default value for the first value 725.

After a first attribute 625, a first operand 715, and a first value 725 have been selected, a filter expression 730 may be derived. In simple cases, the filter expression 730 may be derived by concatenating the first attribute 625 with the first operand 715 and the first value 725 to form a logical expression. For example, a filter expression may include the logical expression “Date After Feb. 1, 2012”. More advanced filtering expressions may also be formed involving multiple triplets of attributes/operands/values, or involving multiple operands and/or multiple values for single attributes. These more complex filter expressions will be discussed further herein below.

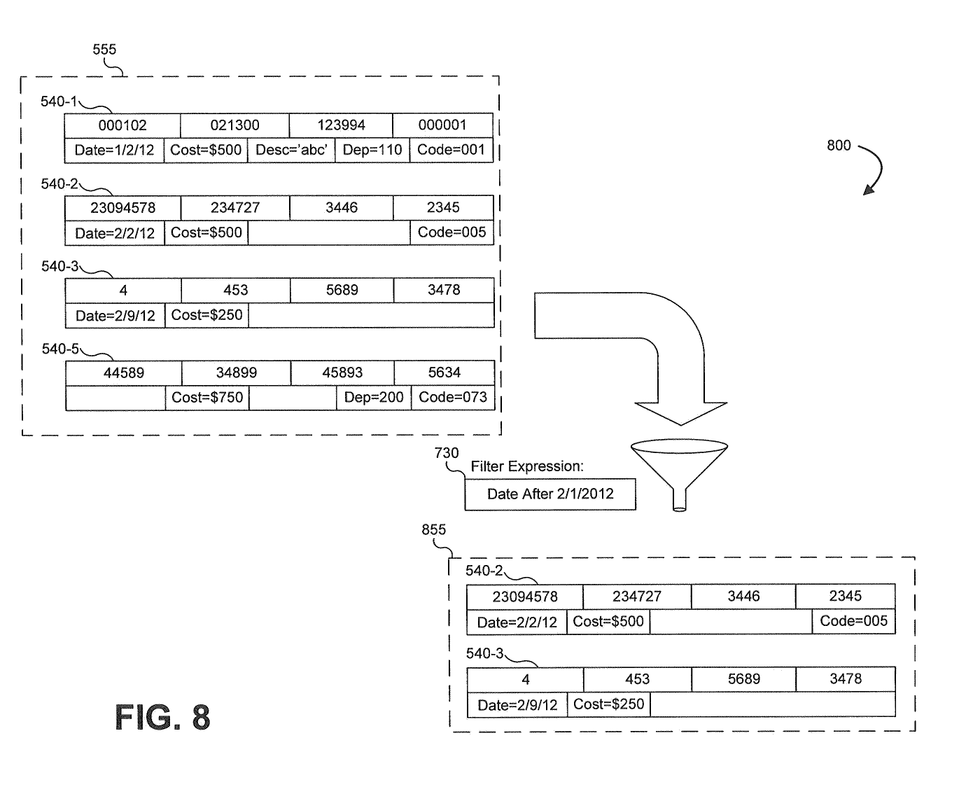

FIG. 8 illustrates a block diagram 800 of filtering the plurality of accounts 555 according to a filter expression 730, according to one embodiment. After the filter expression 730 has been defined, the plurality of accounts 555 may be filtered according to the filter expression 730. Generally, filtering may be defined as removing accounts from the plurality of accounts that do not have an attribute and value that satisfies the filter expression. For example, if an account does not have the first attribute 625, then that account may be removed. As another example, if an account does have the first attribute 625, but the value assigned to the first attribute 625 does not satisfy the filter expression, then that account could also be removed.

In the example of FIG. 8, account 540-5 may be removed from the plurality of accounts 555 because it does not have an attribute named “Date”. Furthermore, account 540-1 may also be removed because the value of the “Date” attribute does not satisfy the filter expression 730. In this case, the date of Jan. 2, 2012 for account 540-1 is not “After Feb. 1, 2012” according to the filter expression 730. After the filtering operation is complete, a filtered plurality of accounts 855 may remain. In this case account 540-2 and account 540-3 may remain in the filtered plurality of accounts 855 because they both have date attributes with values that satisfy “After Feb. 1, 2012”.

Although a simple filtering operation is described in FIG. 8, more complex filtering operations are also possible. In other embodiments, filtering expressions that are made up of multiple attributes, operands, and/or values may be used. For example, a “Date” attribute may use the “Between” operand, which in turn may use two values, i.e. two dates between which satisfying values may reside. In this case, both a first value 725 and a second value may be selected to develop the filter expression 730. In another embodiment, complex filtering expressions may be constructed using multiple simple filter expressions, as will be discussed further herein below.

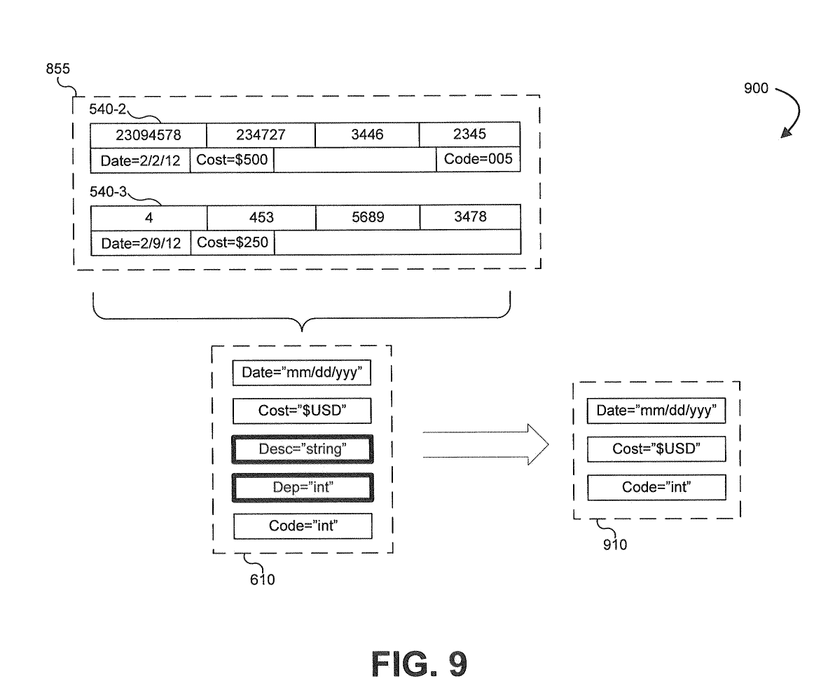

FIG. 9 illustrates a block diagram 900 for dynamically adjusting the plurality of attributes 610 for subsequent filtering operations, according to one embodiment. The plurality of accounts 555 prior to the first filtering operation may contain many attributes. After the filtering operation, the filtered plurality of accounts 155 may contain far fewer accounts. Consequently, far fewer attributes may be associated with at least one of the filtered plurality of accounts 855. Dynamically adjusting the plurality of attributes 610 may be comprised of removing attributes that are no longer associated with at least one of the filtered plurality of accounts 155 after the filtering operation. This may dramatically simplify the selection of subsequent filtering attributes for users who wish to continue with subsequent filtering operations.

In the example of FIG. 9, any attributes in the plurality of attributes 610 that are not associated with at least one of the accounts in the filtered plurality of accounts 855 may be removed. The attributes “Desc” and “Dep” representing a description and a department, respectively, may be removed from the plurality of attributes 610 because they are not associated with at least one account in the filtered plurality of accounts 855. A filtered plurality of attributes 910 may be comprised of any remaining attributes that are associated with at least one of the filter plurality of accounts 855. The filter plurality of attributes 910 may then be used in subsequent filtering operations to further refine the filtered plurality of accounts 855.

Subsequent filtering operations may follow the same method used in the first filtering operation just described. For example a second attribute in the filter plurality of attributes 910 may be selected, along with a corresponding second operand and second value, which may be used to form a second filter expression. The second filter expression may be used to further eliminate accounts from the filtered plurality of accounts 855. This filtering operation may continue until a desired set of accounts has been obtained. Each successive filtering operation may follow the same procedure, or may alter the operation based on the number of remaining accounts. In one embodiment, subsequent filtering operations may further filter the plurality of attributes by removing attributes that are very dissimilar to the attribute selected in the previous filtering operation. For example, it may be determined by previous filtering operations that although at least one of the remaining accounts is associated with a “Cost” attribute, it is not similar enough from the other remaining and/or selected attributes, and thus may be eliminated from consideration for future filtering operations.

In one embodiment, it is possible for users to define custom attributes for accounts before, during, and after a filtering process. In this embodiment, whenever a new attribute is created and/or associated with one of the accounts in the plurality of accounts 555, the plurality of attributes 610 may be dynamically adjusted to include the new user-defined attributes. Similarly, if a user-defined attribute is removed from an account, then the plurality of attributes 610 may be dynamically adjusted to remove the removed user-defined attribute. Thus, the plurality of attributes 610 may be dynamically adjusted in real-time to reflect changes made by a user. Oftentimes, changes may be made for the direct purpose of including or excluding these attributes for the filtering process.

FIG. 10 illustrates an interface 1000 for generating, editing, and saving filter expressions. Interface 1000 may be implemented with the transactional dashboard 330 of FIG. 3, and may provide an input to the edit filter module 360. Here, a first attribute may be selected with control 1010, a first operand may be selected with control 1020, and a first value may be input/selected with control 1030. These three controls may be used to generate a simple filter expression. If additional values need to be selected according to a select operand, then additional controls may be dynamically added to the interface 1000 to facilitate additional value selections. For example, if the operand “Between” is selected in conjunction with a “Date” attribute, then two calendar controls may be provided to the user to select two different dates.

The conjunction control 1040 may be used to join multiple simple filter expressions to form complex filter expressions. For example, simple filter expression 1050 representing “Name Starts with ‘Acct’” may be joined to simple filter expression 1060 representing “Description Does not contain ‘Some Text’” with the conjunction “And”. Any type of logical operator may be used as a conjunction to join simple expressions. Additionally, a user may create new connector and provide instructions on how it may be used to connect simple expressions.

It may also be useful to group sub-expressions together when forming complex filter expressions. A group button 1070 may be used to group expressions together for evaluation purposes. In one embodiment, a group may be a way of enforcing an order of operations during the evaluation of the expression, much like a set of parentheses is used in evaluating mathematical expressions. Multiple groups may be joined together with conjunctions in the same way that simple expressions are joined together using conjunctions. For example group 1080 representing two simple expressions be joined to group 1090 representing two additional simple expressions. The expressions within group 1080 and group 1090 may both be evaluated first, and then the results of those two groups may be evaluated using the conjunction “Or”. It will be understood in light of this disclosure, that highly complex filters may be designed using groups and conjunctions.

Control 1095 may be used to give a name and description to a filter created by user. Thus, in creating a filter expression, a user may define custom filters and save those filters for later use with the same plurality of accounts, or with a different plurality of accounts. Using interface 1000, a user may define a set of custom filters that may be saved with the filtering system 300, or with a user profile such that the set of custom filters are available to the user on subsequent sessions.

User-defined filters that are created during a first user session may be loaded and used for filtering in a second user session. A second user session may be a session by the same user or a different user wherein a second plurality of accounts is filtered that is different than the plurality of accounts filtered in the first user session. Alternatively, the second user session may include a second plurality of accounts that is the same as the first plurality of accounts, but the filtering takes place at a different time. In one embodiment, a computer system may automatically recognize or determine that a saved filter expression is applicable to the second plurality of accounts in the second user session and automatically load the saved filter expression for use. A saved filter expression may be applicable if it includes similar attributes, operands, and/or values as those found in the second plurality of accounts.

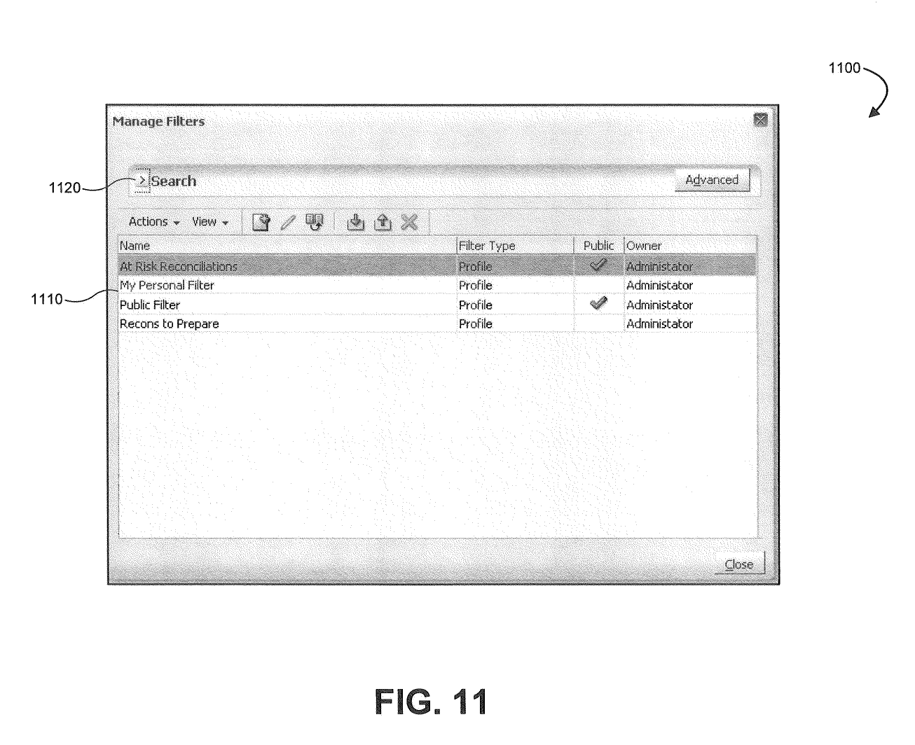

Generally, any filters that have been saved by a user may be searched and retrieved for future use. FIG. 11 illustrates an interface 1100 that may be used to manage filters, according to one embodiment. Window 1110 may be used to display both custom filters defined by the user, along with system filters that accompany various account systems. Metadata for each filter may be displayed including the name of the filter, a filter type, a security attribute defining whether the filter is public or private, and/or an owner of the filter. The owner may be a class of user, such as an administrator, an organization, or an individual. In the case of an individual, the filter metadata displayed in window 1110 may, be filters that are saved to an individual profile, or to a common profile for a group of users.

A search field 1120 may allow a user to search among the available filters according to any of the available filter attributes. For example, the user may type in “Date”, and the interface 1100 may return a list of filters that use the “Date” attribute in their filter expression. Similarly, user may input an operand, such as “Greater Than”, or a value, such as “$500”, into the search field 1120. In response, filters using the operand “Greater Than” or the value “$500” may be returned and displayed in window 1110.

In one embodiment, attributes of accounts may be divided into many different types of attributes. One way to divide attributes may be where they are stored. Attributes that are tied closely to a specific account may be stored with the account object or as a field of the account object. Attributes may also be assigned to accounts, yet be closely tied to something else, such as a particular type of user. In these cases, these attributes may be stored in a user profile and simply be referenced by the account. Other attributes may be closely tied to a particular department. Particularly, user-defined attributes may be stored in the attribute creator's user profile. These attributes may also be stored in a department profile and be referenced by the account. Attributes stored separately from an account may be referenced in the account object, such that when an account object is examined, these attributes stored separately may be associated with the account. To a user searching for accounts using the system, the source and location of an attribute may be transparent, thus allowing the user to filter attributes based on their source, i.e. where they are stored. In another embodiment, storage of attributes separate from accounts may be abstracted from the user. Thus, a user may have no need to know where an attribute is stored relative to its corresponding account object.

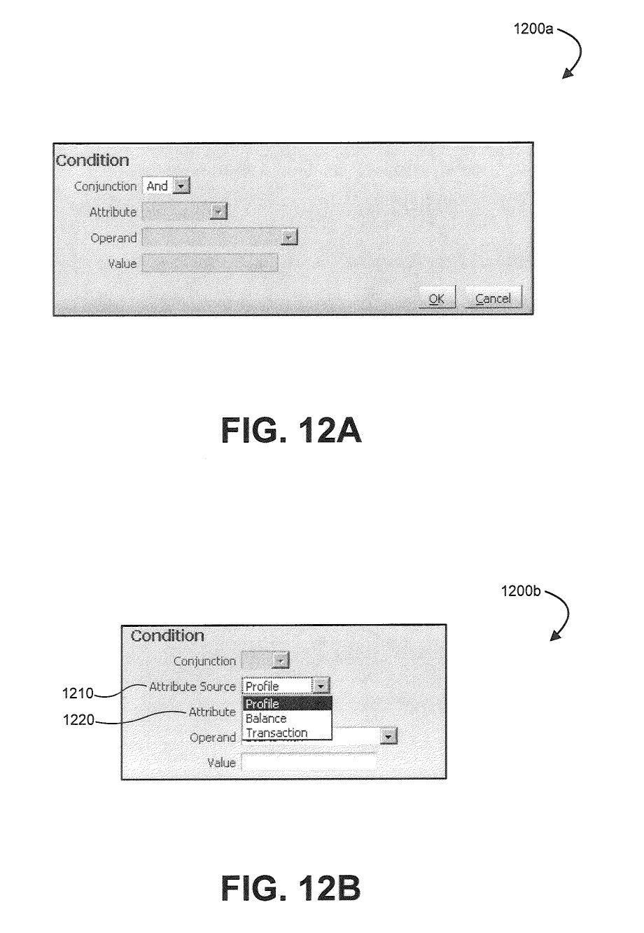

FIG. 12A illustrates an interface 1200a for defining filter expressions, according to one embodiment. This interface may be part of interface 1000 in FIG. 10 and may be used in any user interface wherein filter expressions may be defined. FIG. 12B illustrates another interface 1200b for defying filter expressions. Interface 1200b includes an attribute source drop-down box 1210 that may be available for filters used to reconcile accounts. Reconciliations can have hundreds of attributes: some that are pulled from the profile definition of from the user of the account, some from the format and balance information the account, and some from the transaction definition. In addition, some attributes may be applied to different sources. For instance, a color attribute may be assigned to both the format and the profile. To alleviate the confusion of the source of the attribute, reconciliation filters may have an attribute source drop-down box 1210 to select among these alternatives. A selection made in the attribute source drop-down box 1210 may affect the listed attributes presented in the attribute drop-down box to 120.

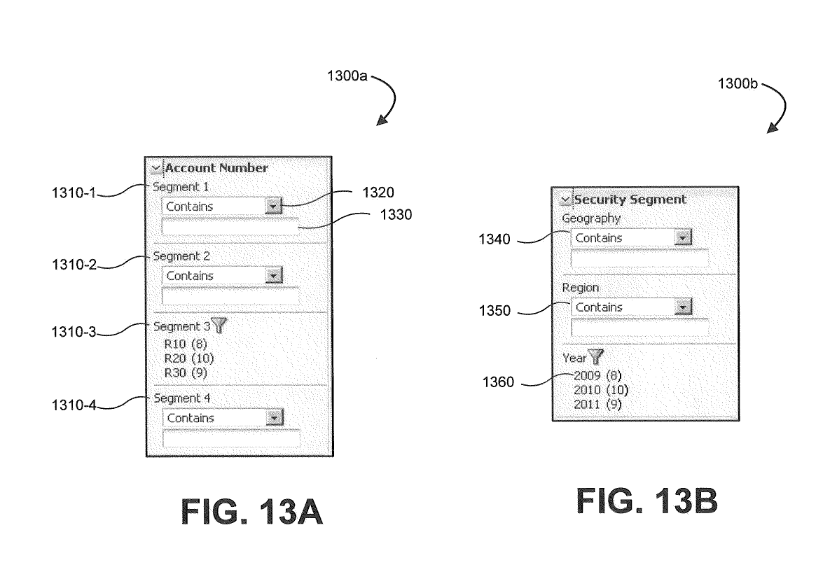

FIG. 13A illustrates an interface 1300a for filtering by segments account. As described earlier, and account number may be divided into segments. Each segment of an account number may be used to identify a characteristic of the account. For example, the final segment of an account may be decoded to indicate a date or location at which the account originated. In some embodiments, it may be helpful to consider account number segments to be similar to attributes. Thus, the segments may be used for filtering, in the same way that attributes may be used. However, because of the special nature of account segments, it may be helpful to have a special interface for using segments to derive filter expressions.

Interface 1300a may be use to generate filter expressions from account segments. In this example, an account number may be divided into four different segments, namely segment 1310-1, segment 1310-2, segment 1310-3, and segment 1310-4. Each segment may have its own operand drop-down box 1320 containing operands, as well as a value box 1330 in which a value input may be received. In one embodiment, each segment and account number may be used in a filter expression. In another embodiment, a single section may be used, and the other sections may be left blank or have the corresponding control disabled.

FIG. 13B illustrates an interface 1300b for filtering by a security segment. In one embodiment, segments may be filtered by a geography attribute 1340. Additionally, objects may be filtered by a region attribute 1350 and a year attribute 1360. These attributes are merely exemplary, and many other types of attributes may be used.

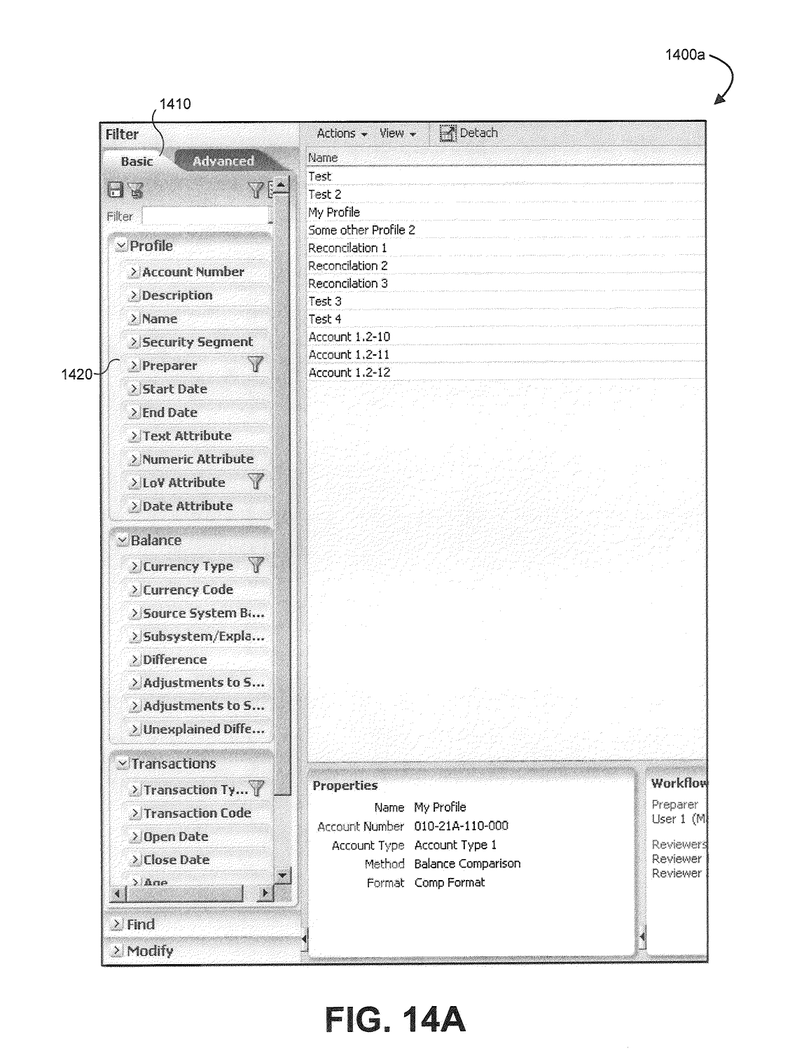

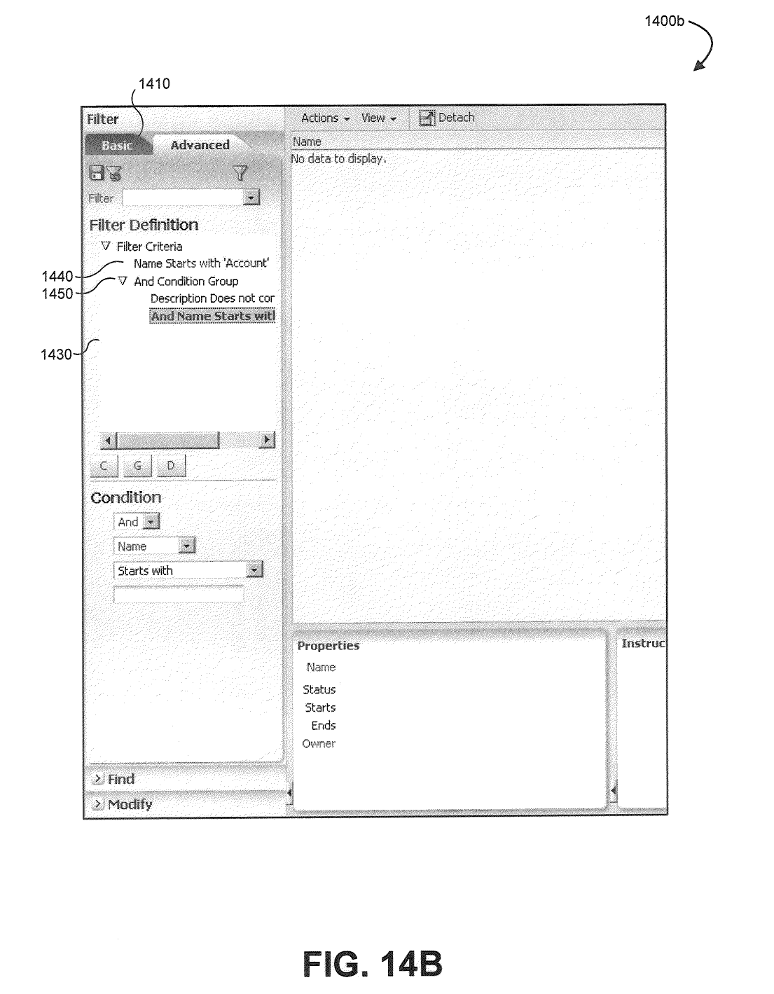

FIG. 14A illustrates an interface 1400a for designing a basic filter, according to one embodiment. Tab control 1410 may be used to switch between basic filtering and advanced filtering. Basic filtering may consist of simple filter expressions that may be chosen by a user by graphically selecting options from menu in a basic filter window 1420. Thus, using basic filtering, the user may click a series of controller buttons in the basic filter window 1420 to create a simple filter graphically without the need to deal with complex Boolean expressions. This may be useful for quick filtering operations and/or beginning users.

By selecting the advanced tab in the tab control 1410, a user may switch the interface 1400a to create advanced filter definitions. FIG. 14B illustrates an interface 1400b for designing advanced filter expressions. The advanced filter window 1430 may contain interfaces already described, such as interface 1000 in FIG. 10, interface 1200a in FIG. 12A, and interface 1200b in FIG. 12B. Note that these interfaces may be used to join together simple filtering expressions to form more complex filtering expressions. The advanced filter window 1430 may be useful for more particular filtering and/or more advanced users.

In one embodiment, a user may begin designing a simple filter in the basic filter window 1420. Subsequent to the beginning of the design of a basic filter, a user may decide to instead design a more advanced filter. If a user clicks on the advanced tab in the tab control 1410, the display may switch from the basic filter window 1420 to the advanced filter window 1430. Any partial basic filter definition that the user had created a basic filter window 1420 prior to the switch to the advanced filter window 1430 may be preserved in the advanced filter window 1430. For example, if a user had created a basic filter comprised of “Name Starts with ‘Account’”, this basic filter could be automatically imported to the advanced filter window 1430 when switching between the two tabs as simple filter expression 1440. After the switch, additional simple filter expressions 1450 could be added to the simple filter expression 1440.

Similarly, if a user were to begin and/or continue designing a complex filter expression in the advanced filter window 1430, and then subsequently switched back to the basic filter window 1420, a portion of any complex filter expression could be saved and automatically inserted into the basic filter window 1420. If the filter design began in the basic filter window 1420, and user was merely switching back after attempting more advanced filter design, then any basic filter that began in the basic filter window could be preserved when switching back. On the other hand, if the basic filter that began in the basic filter window 1420 is no longer available, or if the basic filter had been significantly altered or removed, then other portions of the more complex filter could be preserved after switching back to the basic filter window 1420. In one embodiment, the first simple filter expression in a complex filter expression could be preserved. In another embodiment, the topmost simple filter expression in a group hierarchy could be preserved. In yet another embodiment, the simple filter expression with the most common attribute in the plurality of accounts could be preserved.

Thus, whole and/or partial filter expressions may be persevered when switching between the basic and advanced interfaces. This may be beneficial if a user begins to attempt a complex filter, but later changes his/her mind and decides to switch back to a simpler interface offered by the basic filter window 1420. Similarly, if a user begins to design a simple filter expression in the basic filter window 1420, the user can freely switch to the advanced filter window 1430 without needing to reinsert any filter expression begun in the basic filter window 1420.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums; such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A method for dynamically filtering a plurality of accounts in an Account Reconciliation Management System, the method comprising:
determining a plurality of attributes, wherein each of the plurality of attributes is associated with at least one of the plurality of accounts;
receiving a selection of a first attribute in the plurality of attributes;
determining a plurality of values, wherein each of the plurality of values are associated with a value type of the first attribute;
determining a plurality of operands, wherein each of the plurality of operands are associated with the first attribute;
receiving a selection of a first operand from the plurality of operands;
receiving a selection of a first value from the plurality of values;
creating a filter expression based on the first attribute, the first value, and the first operand;
filtering the plurality of accounts, wherein the filtering comprises removing accounts from the plurality of accounts that do not satisfy the filter expression;
after filtering the plurality of accounts, determining that a second attribute in the plurality of attributes is not associated with any of the remaining accounts in the plurality of accounts; and
removing the second attribute from the plurality of attributes.

2. The method for dynamically filtering the plurality of accounts in the Account Reconciliation Management System according to claim 1, wherein removing accounts from the plurality of accounts that do not satisfy the filter expression comprises:
removing accounts from the plurality of accounts that are not associated with the first attribute; and
removing accounts from the plurality of accounts that are associated with the first attribute, but that have a value assigned to the first attribute that is excluded according to the filter expression.

3. The method for dynamically filtering the plurality of accounts in the Account Reconciliation Management System according to claim 1, wherein:
the plurality of accounts is a subset of a listing of accounts;
the listing of accounts includes accounts from a plurality of data sources; and
each of the plurality of accounts is associated with at least one attribute.

4. The method for dynamically filtering the plurality of accounts in the Account Reconciliation Management System according to claim 1, further comprising:
receiving a second filter expression;
receiving a second operand;
forming a complex filter expression by combining the filter expression with the second filter expression using the second operand; and
filtering the plurality of accounts, wherein the filtering comprises removing accounts from the plurality of accounts that do not satisfy the complex filter expression.

5. The method for dynamically filtering the plurality of accounts in the Account Reconciliation Management System according to claim 4,
receiving a third filter expression;
receiving a third operand;
forming a grouped filter expression by combining the complex filter expression with the third filter expression using the third operand, wherein a result of the complex filter expression is combined with the third filter expression using the third operand; and
filtering the plurality of accounts, wherein the filtering comprises removing accounts from the plurality of accounts that do not satisfy the grouped filter expression.

6. The method for dynamically filtering the plurality of accounts in the Account Reconciliation Management System according to claim 1, further comprising:
receiving a third attribute, wherein:
the third attribute is associated with at least one of the plurality of accounts; and
the third attribute is user-defined; and
adding, in response to receiving the third attribute, the third attribute to the plurality of attributes.

7. The method for dynamically filtering the plurality of accounts in the Account Reconciliation Management System according to claim 1, further comprising:
removing a third attribute from any of the plurality of accounts that are associated with the third attribute; and
removing the third attribute from the plurality of attributes in response to removing the third attribute from any of the plurality of accounts that are associated with the third attribute.

8. The method for dynamically filtering the plurality of accounts in the Account Reconciliation Management System according to claim 1, further comprising:
storing the filter expression in a user profile in a first user session;
determining, in a second user session, that the filter expression is includes an attribute that is associated with at least one of a second plurality of accounts available for filtering in the second user session;
loading the filter expression; and
using the filter expression to filter the second plurality of accounts in the second user session.

9. The method for dynamically filtering the plurality of accounts in the Account Reconciliation Management System according to claim 1, further comprising:
presenting a basic filter interface that allows for the creation of simple filter expressions;
receiving a basic filter expression created in the basic filter interface;
receiving an first input;
presenting an advanced filter interface in response to the first input, wherein the advanced filter interface allows for the creation of complex filter expressions, and wherein a complex filter expression is a combination of one or more filter expressions; and
automatically providing the basic filter expression from the basic filter interface to the advanced filter interface.

10. The method for dynamically filtering the plurality of accounts in the Account Reconciliation Management System according to claim 1, wherein:
a first account in the plurality of accounts includes an account number;
the account number is divided into a plurality of segments; and
each of the plurality of segments is included in the plurality of attributes.

11. The method for dynamically filtering the plurality of accounts in the Account Reconciliation Management System according to claim 1, wherein each of the plurality of accounts is a reconciliation record.

12. The method for dynamically filtering the plurality of accounts in the Account Reconciliation Management System according to claim 1,
receiving a third attribute, wherein:
the third attribute is associated with at least one of the plurality of accounts; and
the third attribute is user-defined; and
the third attribute is stored separately from the at least one of the plurality of accounts.

13. A computer-readable memory having stored thereon a sequence of instructions which, when executed by one or more processors, causes the one or more processors to filter a plurality of accounts in an Account Reconciliation Management System by:
determining a plurality of attributes, wherein each of the plurality of attributes is associated with at least one of the plurality of accounts;
receiving a selection of a first attribute in the plurality of attributes;
determining a plurality of values, wherein each of the plurality of values are associated with a value type of the first attribute;
determining a plurality of operands, wherein each of the plurality of operands are associated with the first attribute;
receiving a selection of a first operand from the plurality of operands;
receiving a selection of a first value from the plurality of values;
creating a filter expression based on the first attribute, the first value, and the first operand;
filtering the plurality of accounts, wherein the filtering comprises removing accounts from the plurality of accounts that do not satisfy the filter expression;
after filtering the plurality of accounts, determining that a second attribute in the plurality of attributes is not associated with any of the remaining accounts in the plurality of accounts; and
removing the second attribute from the plurality of attributes.

14. The computer-readable memory for dynamically filtering the plurality of accounts in the Account Reconciliation Management System according to claim 13, wherein removing accounts from the plurality of accounts that do not satisfy the filter expression comprises:
removing accounts from the plurality of accounts that are not associated with the first attribute; and
removing accounts from the plurality of accounts that are associated with the first attribute, but that have a value assigned to the first attribute that is excluded according to the filter expression, wherein:
the plurality of accounts is a subset of a listing of accounts;
the listing of accounts includes accounts from a plurality of data sources; and
each of the plurality of accounts is associated with at least one attribute.

15. The computer-readable memory according to claim 13, wherein the instructions further cause the one or more processors to dynamically filter the plurality of accounts in the Account Reconciliation Management System by:
receiving a second filter expression;
receiving a second operand;
forming a complex filter expression by combining the filter expression with the second filter expression using the second operand;
filtering the plurality of accounts, wherein the filtering comprises removing accounts from the plurality of accounts that do not satisfy the complex filter expression;
receiving a third filter expression;
receiving a third operand;
forming a grouped filter expression by combining the complex filter expression with the third filter expression using the third operand, wherein a result of the complex filter expression is combined with the third filter expression using the third operand; and
filtering the plurality of accounts, wherein the filtering comprises removing accounts from the plurality of accounts that do not satisfy the grouped filter expression.

16. The computer-readable memory according to claim 13, wherein the instructions further cause the one or more processors to dynamically filter the plurality of accounts in the Account Reconciliation Management System by:
receiving a third attribute, wherein:
the third attribute is associated with at least one of the plurality of accounts; and
the third attribute is user-defined;
adding, in response to receiving the third attribute, the third attribute to the plurality of attributes;
removing a fourth attribute from any of the plurality of accounts that are associated with the third attribute; and
removing the fourth attribute from the plurality of attributes in response to removing the third attribute from any of the plurality of accounts that are associated with the third attribute.

17. A system comprising:
a processor; and
a memory communicatively coupled with and readable by the processor and having stored therein a sequence of instructions which, when executed by the processor, cause the processor to filter a plurality of accounts in an Account Reconciliation Management System by:
determining a plurality of attributes, wherein each of the plurality of attributes is associated with at least one of the plurality of accounts;
receiving a selection of a first attribute in the plurality of attributes;
determining a plurality of values, wherein each of the plurality of values are associated with a value type of the first attribute;
determining a plurality of operands, wherein each of the plurality of operands are associated with the first attribute;
receiving a selection of a first operand from the plurality of operands;
receiving a selection of a first value from the plurality of values;
creating a filter expression based on the first attribute, the first value, and the first operand;
filtering the plurality of accounts, wherein the filtering comprises removing accounts from the plurality of accounts that do not satisfy the filter expression;
after filtering the plurality of accounts, determining that a second attribute in the plurality of attributes is not associated with any of the remaining accounts in the plurality of accounts; and
removing the second attribute from the plurality of attributes.

18. The system of claim 17, wherein the instructions further cause the processor to dynamically filter the plurality of accounts in the Account Reconciliation Management System by:
storing the filter expression in a user profile in a first user session;
determining, in a second user session, that the filter expression is includes an attribute that is associated with at least one of a second plurality of accounts available for filtering in the second user session;
loading the filter expression; and
using the filter expression to filter the second plurality of accounts in the second user session.

19. The system of claim 17, wherein the instructions further cause the processor to dynamically filter the plurality of accounts in the Account Reconciliation Management System by:
presenting a basic filter interface that allows for the creation of simple filter expressions;
receiving a basic filter expression created in the basic filter interface;
receiving an first input;
presenting an advanced filter interface in response to the first input, wherein the advanced filter interface allows for the creation of complex filter expressions, and wherein a complex filter expression is a combination of one or more filter expressions; and
automatically providing the basic filter expression from the basic filter interface to the advanced filter interface.

20. The system of claim 17, wherein:
a first account in the plurality of accounts includes an account number;
the account number is divided into a plurality of segments; and
each of the plurality of segments is included in the plurality of attributes.
